(19) United States
(12) Patent Application Publication
(10) Pub. No.: US 2018/0013107 A1
(43) Pub. Date: Jan. 11, 2018

(54) ARC-SHAPED BATTERY BOX STRUCTURE FOR LIGHT-FIXTURE

(71) Applicant: Jiangmen Hongsen Electronic Lighting Co., Ltd., Jiangmen City (CN)

(72) Inventor: SU IO LAM, Jiangmen City (CN)

(21) Appl. No.: 15/205,952

(22) Filed: Jul. 8, 2016

(51) Int. Cl. H01M 2/10; H01M 10/42

(52) U.S. Cl. CPC H01M 2/1022; H01M 10/425

(57) ABSTRACT

The present invention discloses an arc-shaped battery box structure for light-fixture, comprising an arc-shaped box body provided with a battery compartment and a battery cover covering the battery compartment in a matching and sealing manner, wherein, the battery cover and the battery compartment are in the shape of an elongated arc and matched with each other; an end portion of the battery cover is inclined and bent towards the battery compartment, or an open end portion of the battery compartment is inclined and bent towards the battery cover, or the end portion of the battery cover and the open end portion of the battery compartment are inclined and bent towards each other; and the battery cover and the battery compartment are quickly interlocked at an arc-shaped side wall.

### FIELD OF THE INVENTION

The present invention relates to an arc-shaped box structure for light-fixture.

### BACKGROUND OF THE INVENTION

Light-fixtures are lamps frequently used in festivals, people give play to their originality design these lamps and lanterns to be in the shape or appearance extremely similar to substances with festival characteristics, elements and the like so as to foil the festive atmosphere. Moreover, due to different using requirements for using safety and outdoor use, the light-fixture usually needs to be matched with dry batteries for direct-current drive. For instance, Christmas light-fixtures are the most common ones. The Christmas light-fixtures in the market are designed into a plurality of different object-imitating models with different shapes, so that the light-fixture needs to be provided with a battery box cooperatively so as to mount batteries and connect a conductor wire. Therefore, the battery box needs to be designed to be capable of matching with the characteristic of special shape of the light-fixture such that the battery box does not affect the mounting and fixation of the light-fixture, and meanwhile convenience in change, waterproof sealing property and durability of the batteries are also guaranteed.

Some light-fixture is of a circular, elliptical or arc strip-shaped structure, and in order to maintain the appearance of the light-fixture, the battery box also needs to be formed in the shape of a corresponding arc strip, so that the battery box is hidden in the whole body of the product. However, a plurality of batteries are generally needed for driving, so that the length of the battery box is relatively long, the battery compartment is also designed in the shape of a relatively long strip, the arc-shaped upper cover-type battery cover and two ends of the battery compartment cannot be sealed and closed, thus the condition of water leakage easily appears, the outdoor application durability of the battery box is greatly influenced, and the light-fixture cannot be normally used. Due to the fact that the battery compartment needs a plurality of batteries, there is a case that the battery cover is divided into a plurality of structures corresponding to the batteries so as to avoid the defects in closing of the battery cover and the battery compartment, but defects in a separated and sealing structure of the battery compartment between the battery covers arise accordingly. The two structures are both extremely inconvenient in practical applications.

### SUMMARY OF THE INVENTION

In order to solve the disadvantages in the prior art, the present invention provides an arc-shaped battery box structure of a light-fixture, and the arc-shaped battery box structure is good in sealing property, convenient to use and durable.

The technical scheme adopted for solving the technical problems of the present invention is as follows:

An arc-shaped battery box structure for light-fixture, comprising an arc-shaped box body provided with a battery compartment and a battery cover covering the battery compartment in a matching and sealing manner; wherein, the battery cover and the battery compartment are in the shape of an elongated arc and matched with each other; an end portion of the battery cover is inclined and bent towards the battery compartment, or an open end portion of the battery compartment is inclined and bent towards the battery cover, or the end portion of the battery cover and the open end portion of the battery compartment are inclined and bent towards each other; and the battery cover and the battery compartment are quickly interlocked at an arc-shaped side wall.

As an improvement to the technical scheme, the box body is further provided with a circuit board compartment adjacent to the battery compartment and a circuit board cover covering the circuit board compartment in a matching and sealing manner, the circuit board cover and the circuit board compartment are detachably buckled.

As an improvement to the technical schemes, the battery cover and the battery compartment are detachably hinged on an arc side, and respectively provided with clamping hooks and clamping parts matched on an opposing arc side, one end of each of the clamping hooks is movably mounted on an arc-shaped side wall of the battery cover, and the other end is correspondingly clamped with one of the clamping parts of the battery compartment.

Further, the clamping hooks are T-shaped each having a transverse axis body at an end thereof, correspondingly the battery cover is provided with hinge seats arranged on a side wall thereof and detachably engaged with the axis bodies of the clamping hooks.

Further, the battery cover is provided with a hinge column on the side thereof on which the battery compartment is detachably hinged, and the battery compartment is provided with hinge buckles arranged on the outer wall thereof and detachably and movably buckled with the hinge column.

Further, the battery cover and the battery compartment are hinged at the middle of the outer arc side thereof or of the box body, three clamping hooks and three clamping parts are distributed on the inner arc side of the box body at equal intervals, respectively, and the battery cover is inclined or bent towards the battery compartment from the end portion of the inner arc side and the middle of the outer arc side to the end portion of the outer arc side.

Further, the circuit board cover or the circuit board compartment is provided with a fixing seat for fastening a wire in the position corresponding to where the circuit board is mounted, the fixing seat is in the shape of a vertical plate with a notch formed thereon for accommodating the wire, and provided with a pressure rod mounted thereon in a matching manner.

Further, the circuit board cover is provided with buckle lugs extending towards the outer wall of the circuit board compartment, and the circuit board compartment on the outer wall thereof is provided with convex buckle plates corresponding to the buckle lugs; the circuit board compartment is provided with a concave wire outlet formed in the edge of the wall thereof, in which a pressure head and a pressure pad are mounted and abut against each other up and down to seal and wrap the wire.

Further, the pressure head is provided with a lug boss abutting against the pressure pad, and the pressure pad is provided with a notch accommodating the wire and formed in the surface thereof abutting against the pressure head; the circuit board compartment is provided with a positioning column arranged in the wire outlet, and the pressure pad is provided with an inserting hole corresponding to the positioning column; the pressure pad is further provided with a concave groove formed in the edge thereof and covering the edge of the wire outlet, and correspondingly the pressure head is provided with a concave groove covering the edge of the circuit board cover.

Further, the battery cover is provided with a seal ring abutting against the battery compartment, and the circuit board cover is provided with a seal ring abutting against the circuit board compartment; the battery cover and the circuit board cover are provided with grooves formed in the inner sides of edges thereof respectively for receiving the seal rings, and the battery compartment and the circuit board compartment are provided with raised lines arranged on the edges of the openings thereof respectively abutting against the seal rings; and the circuit board cover is provided with a control switch.

The beneficial effects of the invention are as follows: the battery compartment is completely and tightly covered by the arc-shaped battery cover of the battery box, so that the disadvantage that two ends of an arc-shaped structure cannot be sealed and covered is effectively avoided; moreover, the arc-shaped battery box structure can be mounted in combination with the light-fixture in a shape matching manner, and the battery box is convenient to use, easy to mount, high in durability and use value.

### BRIEF DESCRIPTION OF THE DRAWINGS

The present invention will be further described in conjunction with the following drawings and embodiments, wherein:

FIG. 1 is a schematic view of a battery box structure in an embodiment according to the present invention;

FIG. 2 is an exploded view of the battery box structure with an opened cover, in the embodiment of FIG. 1;

FIG. 3 is a schematic view of the battery box structure from another angle, in the embodiment of FIG. 1; and

FIG. 4 is an exploded view of a circuit board cover, a pressure head and seal rings in the embodiment of FIG. 1.

### DESCRIPTION OF EMBODIMENTS

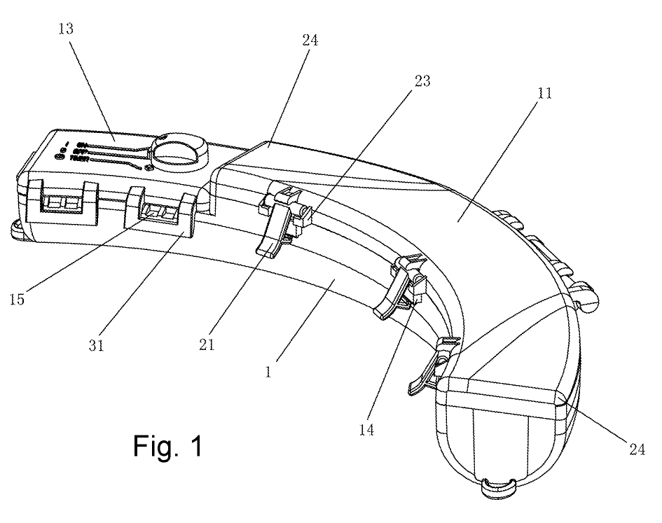

As shown in FIGS. 1 to 3, an arc-shaped battery box structure according to the invention comprises a box body 1 in an elongated arc shape. The box body 1 is provided with a battery compartment 11 which is covered and sealed by a battery cover 2. The battery cover 2 and the battery compartment 11 are matched with each other, i.e. both in an elongated arc shape. An end portion of the battery cover 2 is inclined and bent towards the battery compartment 11, or an open end portion of the battery compartment 11 is inclined and bent towards the battery cover 2, or an end portion of the battery cover 2 and an open end portion of the battery compartment 11 are inclined and bent towards each other. The battery cover 2 and the battery compartment 11 are quickly interlocked at arc-shaped side walls thereof. The battery cover 2 is provided with reinforcing ribs on the inner side surface thereof. Optionally, for outdoor use, the battery cover 2 may be provided with a seal ring mounted thereon, abutting against the battery compartment 11, but for indoor use, the seal ring may not be necessary. Due to the fact that the end portion of the battery cover 2 and the end portion of the battery compartment 11 are inclined or bent towards each other, elastic deformation and internal stress are produced when the battery cover 2 and the battery compartment 11 are closed and interlocked, rendering the battery cover 2 and the battery compartment 11 to abut against each other more tightly, thereby to effectively prevent the end portion of the battery cover 2 and the end portion of the battery compartment 11 from generating a gap caused by their arc shape when they are closed.

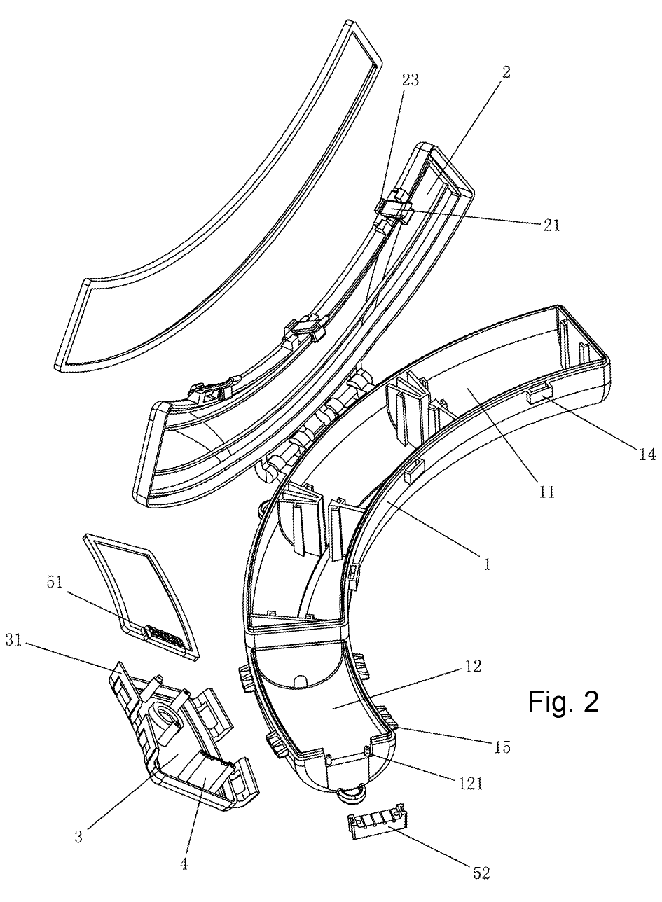

As shown in FIG. 2, the box body 1 is further provided with a circuit board compartment 12, and correspondingly, a matched circuit board cover 3 is provided to cover and seal the circuit board compartment 12. The circuit board compartment 12 is positioned at one end of the battery compartment 11, and separated from the battery compartment 11 by a separation box wall therebetween. In this case, the circuit board compartment 12 and the battery compartment 11 are communicated through a passage. Alternatively, the battery compartment 11 and the circuit board compartment 12 may be configured to form a common cavity of the box body 1. The circuit board cover 3 and the circuit board compartment 12 are detachably buckled. In a similar way, the circuit board cover 3 may or may not be provided with a seal ring abutting against the circuit board compartment 12. The battery compartment 11 and the circuit board compartment 12 are used for receiving a battery and a circuit board, respectively, which are electrically connected through a wire. The circuit board is electrically connected with the light-fixture through a wire extending out of the box body 1 in a sealing manner. The battery cover 2 and the circuit board cover 3 are buckled onto the box body 1 easily, and the battery cover 2 can be quickly opened for convenience in mounting and replacing the battery.

As shown in FIGS. 1 to 3, the battery cover 2 and the battery compartment 11 are detachably hinged on an arc side, and provided with clamping hooks 21 and clamping parts 14 matched with the clamping hooks 21 on an opposing arc side. One end of each clamping hook 21 is movably mounted on the arc-shaped side wall of the battery cover 2, and the other end of each clamping hook 21 is correspondingly clamped with one of the clamping parts 14 of the battery compartment 11, and micro-convex portions are respectively formed at the clamping positions for interlocking. The battery cover 2 is rotated about the hinge to close the battery compartment 11 in a flexible manner, and the clamping hooks 21 are rotated to engage with the clamping parts 14 at the same time to lock the battery cover 2, such that the opening and closing of the batter cover are extremely quick and convenient, and the installation, assembly and replacement are also very simple.

As shown in FIGS. 1 and 2, the clamping hooks 21 are T-shaped, each having a transverse axis body at the end thereof connected with the battery cover 2, correspondingly the battery cover 2 is provided with hinge seats 23 on the side wall thereof, in which the axis bodies of the clamping hooks 21 are detachably mounted. Each of the hinge seats 23 is provided with a semi-open type triangle three-point clamping buckle to engage with the axis body of one clamping hook 21, such a semi-open type fixing structure enables the clamping hooks 21 to embed into the hinge seat 23 easily, such that the mounting would be extremely convenient.

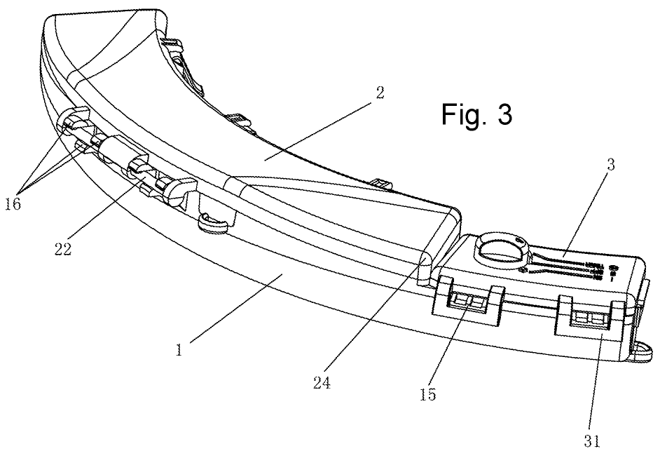

As shown in FIGS. 2 and 3, the battery cover 2 is provided with hinge columns 22 on the side thereof where it is detachably hinged with the battery compartment 11, correspondingly the battery compartment 11 on the outer wall thereof is provided with hinge buckles 16 detachably and movably buckled with the hinge column 22. Each of the hinge buckles 16 is provided with a three-point clamping buckle in an inverted triangle arrangement to buckle one of the hinge columns 22, such a semi-open type structure enables the hinge column 22 to embed into the hinge buckles 16 easily.

As shown in FIGS. 1 to 3, preferably, the battery cover 2 and the battery compartment 11 are hinged at the middle of the outer arc sides thereof or the box body 1. Three clamping hooks 21 and the three clamping parts 14 are distributed on an inner arc side of the box body 1 at equal intervals respectively. The battery cover 2 is inclined or bent towards the battery compartment 11 from an end portion of the inner arc side and a middle portion of the outer arc side to an end portion of the outer arc side, namely an outer end corner 24 of the battery cover 2 is where battery cover 2 is most inclined or bent towards the battery compartment 11 or the box body 1. The battery cover 2 and the battery compartment 11 in the hinging position, the clamping hooks 21 and the clamping parts 14 form a triangular buckling for the interlocking of the battery cover 2 and the battery compartment 11.

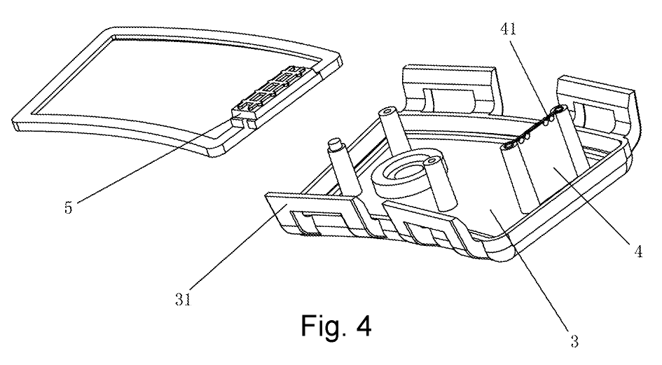

As shown in FIGS. 2 and 4, the circuit board can be secured on the circuit board cover 3 or in the circuit board compartment 12. The circuit board cover 3 or the circuit board compartment 12 is provided with a fixing seat 4 for fastening a wire in a position corresponding to where the circuit board is mounted. In the embodiment as shown in the figures, preferably, the fixing seat 4 is integrally formed with the circuit board cover 3, in a vertical plate shape, and provided with a notch for accommodating the wire. The fixing seat 4 is further provided with a pressure rod 41 mounted thereon in a matching manner and fixed by means of screw nails or in other manners for pressing the wires into the notch of the fixing seat 4, such that the faults caused by the wires pulled off from the circuit board directly by an external force can be effectively prevented

As shown in FIGS. 1 to 3, the circuit board cover 3 is provided with a plurality of buckle lugs 31 extending towards the outer wall of the circuit board compartment 12, and the circuit board compartment 12 is provided with a plurality of buckle plates 15 convexly formed on the outer wall thereof and corresponding to the buckle lugs 31. The buckle plates 15 are provided with reinforcing ribs. Two buckle lugs 31 are arranged on either side of the circuit board cover 3 and buckled with the respective buckle plates 15. The buckling of the buckle lugs 31 is realized by the instantaneous elastic deformation of its material, and thus is firmer than a common movable buckling.

As shown in FIG. 2, the circuit board compartment 12 is provided with a concave wire outlet formed in the compartment wall edge thereof opposite to the circuit board cover 3, in which a pressure head 51 and a pressure pad 52 are mounted and abut against each other up and down to seal and wrap the wire.

As shown in FIG. 2, the pressure head 51 is provided with a lug boss in strip shape, # shape or other shapes, abutting against the pressure pad 52, and the pressure pad 52 is provided with a notch concavely formed in the surface thereof abutting against the pressure head 51, for accommodating the wire. The circuit board compartment 12 is provided with a positioning column 121 on the wire outlet thereof, and the pressure pad 52 is provided with an inserting hole corresponding to the positioning column 121. The pressure pad 52 in the edge thereof is further provided with a concave groove covering the edge of the wire outlet, and the pressure head 51 is also provided with a concave groove covering the edge of the circuit board cover 3. A sealing waterproof effect for the wire extending out of the box body 1 can be effectively realized by means of the pressure head 51 and the pressure pad 52.

As shown in FIGS. 2 and 4, the battery cover 2 and the circuit board cover 3 are provided with seal rings, and grooves matched with the seal rings and formed in the edge inner sides thereof, respectively. In addition to above, the battery compartment 11 and the circuit board compartment 12 are further provided with raised lines abutting against the seal rings and arranged on the opening edges thereof, respectively. The pressure head 51 and the seal rings are integrally formed. The seal ring on the battery cover 2 has an L-shaped cross section, and the seal ring of the circuit board cover 3 has a rectangular cross section. The circuit board cover 3 is further provided with a rotary knob, a press butt, a wireless controller or another control switch for operating and switching on/off of the light-fixture connected.

As shown in FIGS. 1 to 3, the battery compartment 11 is internally provided with a plurality of battery mounting grooves. The seal rings, the pressure head 51 and the pressure pad 52, which are made of flexible glue or silica gel, as a whole surround the battery mounting grooves, and the seal rings are hidden on the inner side of the battery cover 2, thereby avoiding the influence of exposure on the integral appearance of the battery box as well as reducing the influence of aging on the seal rings. In addition, the battery box is further provided with a connecting ring arranged on the outer wall thereof for connecting the battery box to a wall body or a light-fixture in an easy and firm manner. The reinforcing ribs are also arranged on the inner side of the circuit board cover 3 so as to reinforce the strength.

The invention is not limited to the embodiments hereinbefore described which may be varied in construction and detail without departing from the spirit of the invention.

1. An arc-shaped battery box structure for light-fixture, comprising:
an arc-shaped box body provided with a battery compartment and a battery cover covering the battery compartment in a matching and sealing manner;
wherein,
the battery cover and the battery compartment are in the shape of an elongated arc and matched with each other;
an end portion of the battery cover is inclined and bent towards the battery compartment, or an open end portion of the battery compartment is inclined and bent towards the battery cover, or the end portion of the battery cover and the open end portion of the battery compartment are inclined and bent towards each other; and
the battery cover and the battery compartment are quickly interlocked at an arc-shaped side wall.

2. The arc-shaped battery box structure for light-fixture according to claim 1, wherein the box body is further provided with a circuit board compartment adjacent to the battery compartment and a circuit board cover covering the circuit board compartment in a matching and sealing manner, the circuit board cover and the circuit board compartment are detachably buckled.

3. The arc-shaped battery box structure for light-fixture according to claim 1, wherein the battery cover and the battery compartment are detachably hinged on an arc side, and respectively provided with clamping hooks and clamping parts matched on an opposing arc side, one end of each of the clamping hooks is movably mounted on an arc-shaped side wall of the battery cover, and the other end is correspondingly clamped with one of the clamping parts of the battery compartment.

4. The arc-shaped battery box structure for light-fixture according to claim 3, wherein the clamping hooks are T-shaped each having a transverse axis body at an end thereof, correspondingly the battery cover is provided with hinge seats arranged on a side wall thereof and detachably engaged with the axis bodies of the clamping hooks.

5. The arc-shaped battery box structure for light-fixture according to claim 3, wherein the battery cover is provided with a hinge column on the side thereof on which the battery compartment is detachably hinged, and the battery compartment is provided with hinge buckles arranged on the outer wall thereof and detachably and movably buckled with the hinge column.

6. The arc-shaped battery box structure for light-fixture according to claim 3, wherein the battery cover and the battery compartment are hinged at the middle of the outer arc side thereof or of the box body, three clamping hooks and three clamping parts are distributed on the inner arc side of the box body at equal intervals, respectively, and the battery cover is inclined or bent towards the battery compartment from the end portion of the inner arc side and the middle of the outer arc side to the end portion of the outer arc side.

7. The arc-shaped battery box structure for light-fixture according to claim 2, wherein the circuit board cover or the circuit board compartment is provided with a fixing seat for fastening a wire in the position corresponding to where the circuit board is mounted, the fixing seat is in the shape of a vertical plate with a notch formed thereon for accommodating the wire, and provided with a pressure rod mounted thereon in a matching manner.

8. The arc-shaped battery box structure for light-fixture according to claim 2, wherein the circuit board cover is provided with buckle lugs extending towards the outer wall of the circuit board compartment, and the circuit board compartment on the outer wall thereof is provided with convex buckle plates corresponding to the buckle lugs; the circuit board compartment is provided with a concave wire outlet formed in the edge of the wall thereof, in which a pressure head and a pressure pad are mounted and abut against each other up and down to seal and wrap the wire.

9. The arc-shaped battery box structure for light-fixture according to claim 8, wherein the pressure head is provided with a lug boss abutting against the pressure pad, and the pressure pad is provided with a notch accommodating the wire and formed in the surface thereof abutting against the pressure head; the circuit board compartment is provided with a positioning column arranged in the wire outlet, and the pressure pad is provided with an inserting hole corresponding to the positioning column; the pressure pad is further provided with a concave groove formed in the edge thereof and covering the edge of the wire outlet, and correspondingly the pressure head is provided with a concave groove covering the edge of the circuit board cover.

10. The arc-shaped battery box structure for light-fixture according to claim 2, wherein the battery cover is provided with a seal ring abutting against the battery compartment, and the circuit board cover is provided with a seal ring abutting against the circuit board compartment; the battery cover and the circuit board cover are provided with grooves formed in the inner sides of edges thereof respectively for receiving the seal rings, and the battery compartment and the circuit board compartment are provided with raised lines arranged on the edges of the openings thereof respectively abutting against the seal rings; and the circuit board cover is provided with a control switch.
